(19) United States
(12) Patent Application Publication
(10) Pub. No.: US 2018/0206529 A1
(43) Pub. Date: Jul. 26, 2018

(54) FAST-DISSOLVING, CO-CRYSTALLINE FORMS OF SODIUM CHLORIDE

(71) Applicant: NESTEC S.A., Vevey (CH)

(72) Inventors: Heiko Oertling, Lausanne (CH); Thibaut Alzieu, Lausanne (CH); Rene Fumeaux, Blonay (CH); Benjamin Le Reverend, Neuvecelle (FR); Marina Dupas-Langlet, Orbe (CH); Mathieu Wissenmeyer, Huningue (FR); Julien Mahieux, Ecoteaux (CH)

(21) Appl. No.: 15/747,312

(22) PCT Filed: Jul. 15, 2016
(86) PCT No.: PCT/EP2016/066968

§ 371 Date: Jan. 24, 2018

(30) Foreign Application Priority Data
Jul. 29, 2015 (EP) 15178940.1

(51) Int. Cl. A23K 20/22; A23K 20/163; A23L 27/40; A23L 29/30; A23L 33/125; A23L 33/165

(52) U.S. Cl. CPC A23K 20/22; A23K 20/163; A23L 33/165; A23L 29/30; A23L 33/125; A23L 27/40

(57) ABSTRACT

The invention relates to nutritional compositions comprising carbohydrate⋅sodium chloride co-crystals and to the use of these co-crystals for preparing nutritional compositions, as well as their use as carriers, fillers or stabilizers and ultimately for the acceleration of sodium chloride dissolution when other carbohydrates are present. Furthermore, the present invention is directed to a process for preparing such carbohydrate⋅sodium chloride co-crystals and nutritional compositions comprising such.

### FIELD OF THE INVENTION

The invention relates to nutritional compositions comprising carbohydrate-sodium chloride co-crystals and to the use of carbohydrate-sodium chloride co-crystals for preparing nutritional compositions, and for accelerating sodium chloride dissolution in the presence of further carbohydrates. The invention further relates to a process for preparing carbohydrate-sodium chloride co-crystals and a process for preparing nutritional compositions comprising carbohydrate-sodium chloride co-crystals.

### BACKGROUND OF THE INVENTION

Sodium chloride (NaCl, or simply salt) is commonly used for seasoning, processing and preservation of food products. However, diets with high levels of sodium intake might raise the risk of cardiovascular diseases. Therefore, there is a need for products which allow for reduction of sodium chloride or sodium levels in a more general way in food products.

The synthesis of carbohydrate-sodium chloride co-crystals or related structures has been described in the literature. Rendle et al. describe a characterization of a Glucose monohydrate/sodium chloride complex by X-ray diffraction methods (Journal of Forensic Science Society 1988, 28, 295-297). Mathiesen et al. report the existence of two crystal structures of the complex alpha-D-Glucose⋅NaCl⋅H₂O (2:1:1) (Acta Crystallographica 1998, A54, 338-347). Cochran describes “addition compounds” between Sucrose and sodium halides (Nature, 1946, no. 3982, p. 231) and N. Schoorl discloses a convenient large-scale preparation of the Sucrose⋅NaCl⋅2 H₂O co-crystal (Recueil des Travaux Chimiques des Pays-Bas et de la Belgique 1923, 42, 790-9). Schulze describes a double-salt process for diminishing the crystallization time of Glucose (Die Lebensmittelindustrie, 1963, 10, 7, p. 223). Czugler and Pinter illustrate the synthesis and to a certain extent highlight the structural characterization of crystalline complexes of Ribose with sodium halides (Carbohydrate Research 2011, 346, 1610-1616).

Until present, the dissolution behavior, e.g. the dissolution kinetics of carbohydrate sodium chloride co-crystals and their use, their taste and their stability in food products has not been investigated.

### SUMMARY OF THE INVENTION

The present inventors surprisingly found that sodium chloride provided in form of carbohydrate-sodium chloride co-crystals comprised in nutritional compositions shows significantly improved and accelerated dissolution behavior compared to a standard dry-mix of the individual ingredients, resulting in a homogeneous solutions without lump formation.

Furthermore, it was surprisingly found that carbohydrate-sodium chloride co-crystals attract less humidity than compositions comprising its individual constituents.

In addition, it was surprisingly found that carbohydrate-sodium chloride co-crystals provide a saltier sensation when consumed in the solid state than compositions comprising its respective constituents in pure form.

Accordingly, in a first aspect, the present invention provides a solid or semi-solid nutritional composition comprising carbohydrate⋅sodium chloride co-crystals.

In a preferred embodiment of the first aspect, the carbohydrate of the solid or semi-solid nutritional composition is selected from the group consisting of monosaccharides or disaccharides, mixtures of different monosaccharides, mixtures of different disaccharides, or mixtures of monosaccharides and disaccharides.

Preferably, the monosaccharide of the solid or semi-solid nutritional composition according to the first aspect of the invention is selected from the group consisting of pentoses or hexoses, wherein preferably the pentose is selected from the group consisting of Ribose, Arabinose, Lyxose, Xylose, Ribulose, Xylulose, and wherein preferably the hexose is selected from the group consisting of Glucose, Allose, Altrose, Mannose, Gulose, Idose, Galactose, Talose, Psicose, Fructose, Sorbose, or Tagatose.

Preferably, the disaccharide of the solid or semi-solid nutritional composition according to the first aspect is selected from the group consisting of Sucrose, Lactulose, Lactose, Maltose, Trehalose, Cellobiose, Chitobiose, Kojibiose, Nigerose, Isolmaltose, beta, beta-Trehalose, alfa, beta-Trehalose, Sophorose, Laminaribiose, Gentiobiose, Turanose, Maltulose, Palatinose, Gentiobiulose, Mannobiose, Melibiose, Melibiulose, Rutinose, Rutinulose, or Xylobiose.

For example the carbohydrate of the solid or semi-solid nutritional composition may be selected from the group consisting of Ribose, Glucose, Sucrose, Lactose, Maltose, Mannose, Xylose, Rhamnose, Psicose, Fructose and Tagatose.

In a further preferred embodiment of the first aspect of the invention, the co-crystals of the solid or semi-solid nutritional composition are hydrated or non-hydrated co-crystals. More preferably, the co-crystal is (Glucose)₂⋅sodium chloride⋅monohydrate.

In another preferred embodiment carbohydrate⋅sodium chloride co-crystals according to the first aspect of the invention, are selected from the group consisting of (Glucose)₂⋅sodium chloride⋅monohydrate, Ribose⋅sodium chloride, Sucrose⋅sodium chloride⋅2 H₂O, or a combination thereof.

Preferably, the solid or semi-solid nutritional composition of the invention comprises the carbohydrate⋅sodium chloride co-crystals in a concentration of 0.01-100 wt % based on the weight of the composition, preferably in a concentration of 1-70 wt % based on the weight of the composition, more preferably in a concentration of 5-60 wt % based on the weight of the composition.

In a more preferred embodiment, the solid or semi-solid nutritional composition according to the first aspect of the invention comprises the carbohydrate⋅sodium chloride co-crystals in a concentration of 0.01-5 wt % based on the weight of the composition, preferably in a concentration of 0.1-3 wt % based on the weight of the composition.

Preferably, the solid or semi-solid nutritional composition of the invention exhibits a water activity (a_{w}) not suitable for dissolving the co-crystal. More preferably a_{w} is below 0.90, below 0.85, below 0.80, below 0.75, below 0.65, below 0.60, below 0.50, below 0.45, or below 0.40.

Furthermore, in contemporary automated dispensing systems utilizing individual capsules for portioned preparation of liquid food formulations, e.g. instant soups, beverages or infant formulas, preparation time is very short (commonly less than a minute) and the amount of liquid available for complete dissolution limited. Due to the inherent machine design, additional agitation is not an option and in order to achieve a final product that is fully homogeneous and can be readily consumed, instant and complete dissolution is an absolute prerequisite to deliver a certain range of nutritional products. It has to be guaranteed that after flushing of the capsule no residual powders remains.

In a particularly preferred embodiment of the invention, the solid or semi-solid nutritional composition is selected from the group of a food product, a functional food product, a frozen food product, a dairy product, a microwaveable food product, a confectionery product, a culinary product, a nutritional supplement, or a pet food product, preferably, wherein the food product is a pizza, a savory turnover, a bread, a cookie, a chocolate bar, a caramel sauce, a filling, a candy, a frozen pizza, pasta, gluten-free pasta, a dough, a gluten-free dough, a frozen dough, a chilled dough, a bouillon cube, a gellified concentrated bouillon, an instant soup, a ready-meal, a snack, a culinary aid, a mayonnaise, a spread, a thickener, a kitchen aid, a tastemaker (for example a tastemaker packaged in a sachet together with instant noodles), a pretzel, a potato chip, a tortilla, a cracker, a rice cracker, a topping, a seasoning, a flavor, a seasoning mix, or a salt replacer, a table salt, a sea salt or a fortifying mix or a mineral mix.

Advantageously, the nutritional composition according to the first aspect of the invention further comprises a nutrient selected from the group consisting of fat, protein, vitamin, mineral or carbohydrate.

The nutritional compositions according to the first aspect of the invention may further comprise starch-containing ingredients such as flour. The nutritional compositions according to the first aspect of the invention may further comprise herbs, fats and nucleotides such as inosine monophosphate or guanosine monophosphate.

In a second aspect, the invention relates to the use of carbohydrate⋅sodium chloride co-crystals according to the first aspect of the invention a. for preparing a nutritional composition, preferably wherein the nutritional composition is a food product, a functional food product, a frozen food product, a dairy product, a microwaveable food product, a confectionery product, a culinary product, a nutritional supplement, or a pet food product, preferably, wherein the food product is a pizza, a savory turnover, a bread, a cookie, a chocolate bar, a caramel sauce, a filling, a candy, a frozen pizza, pasta, gluten-free pasta, a dough, a gluten-free dough, a frozen dough, a chilled dough, a bouillon cube, a gellified concentrated bouillon, an instant soup, a ready-meal, a snack, a culinary aid, a mayonnaise, a spread, a thickener, a kitchen aid, a tastemaker, a pretzel, a potato chip, a tortilla, a cracker, a rice cracker, a topping, a seasoning, a flavor, a seasoning mix, or a salt replacer, a table salt, a sea salt or a fortifying mix or a mineral mix, b. as carrier, filler or stabilizer, c. for providing a flavor to a nutritional composition, preferably providing a salty flavor to a nutritional composition.

In a third aspect, the invention provides a process for preparing carbohydrate⋅sodium chloride co-crystals comprising the steps of: a. preparing a solution comprising a sodium chloride and carbohydrate at a temperature of 15-75° C., b. cooling the solution to 25-40° C., c. adding a seeding crystal of carbohydrate⋅sodium chloride co-crystal or a co-crystal isostructural with a carbohydrate⋅sodium chloride co-crystal, d. allowing the formation of crystal, e. isolating the obtained crystals.

In a specific embodiment of the third aspect of the invention, the process for preparing carbohydrate ⋅sodium chloride co-crystals comprises the steps of a. adding carbohydrate and sodium chloride in a concentration range of 0.1:2.0 parts by weight to 2.0:0.1 parts by weight, preferably in a concentration range of 0.2:1.2 parts by weight to 1.2:0.2 parts by weight, more preferably in a concentration range of 1:1 parts by weight, to 1 to 0.5 parts of water at 50-100 rpm, b. stirring the suspension at 55-65° C. and 50-100 rpm for 10-90 minutes, c. cooling the solution to 35-40° C., d. adding seeding crystals, e. stirring the solution until crystal precipitation and filtering the suspension, f. washing of the isolated co-crystals with cold ethanol at room temperature, g. drying of the co-crystals at 15-45° C. under vacuum for 1-3 hours and at 15-25° C. without vacuum for 30-60 hours.

In a fourth aspect, the invention is directed to a process for preparing a nutritional composition comprising the steps of a. performing the steps of the processes according to the third aspect of the invention, b. adding a nutrient selected from the group consisting of fat, protein or carbohydrate, wherein preferably the nutritional composition is selected from the group of a food product, a functional food product, a frozen food product, a dairy product, a microwaveable food product, a confectionery product, a culinary product, a nutritional supplement, or a pet food product, preferably, wherein the food product is a pizza, a savory turnover, a bread, a cookie, a chocolate bar, a caramel sauce, a filling, a candy, a frozen pizza, pasta, gluten-free pasta, a dough, a gluten-free dough, a frozen dough, a chilled dough, a bouillon cube, a gellified concentrated bouillon, an instant soup, a ready-meal, a snack, a culinary aid, a mayonnaise, a spread, a thickener, a kitchen aid, a tastemaker, a pretzel, a potato chip, a tortilla, a cracker, a rice cracker, a topping, a seasoning, a flavor, a seasoning mix, or a salt replacer, a table salt, a sea salt or a fortifying mix or a mineral mix.

### BRIEF DESCRIPTION OF THE FIGURES

FIG. 1 displays the dissolution kinetics as the normalized refractive index in percent over time in seconds of (Glucose)₂⋅NaCl⋅H₂O co-crystals in water (♦), sodium chloride (▴), Glucose monohydrate (▪), anhydrous Glucose (x), a physical mixture of Glucose monohydrate and NaCl (⋅), a physical mixture of anhydrous Glucose and NaCl (▪). Dissolution kinetics were measured by online-refractometry in water over a time period of 0 to 100 seconds while stirring at 500 rpm. The volume of the respective solutions was 60 ml and the particle size of the respective solids was comparable ranging from 100 to 200 μm. It is demonstrated that within 25 seconds about 90% of the co-crystalline material was dissolved in water.

FIG. 2 shows the dissolution kinetics via microscopic analysis.

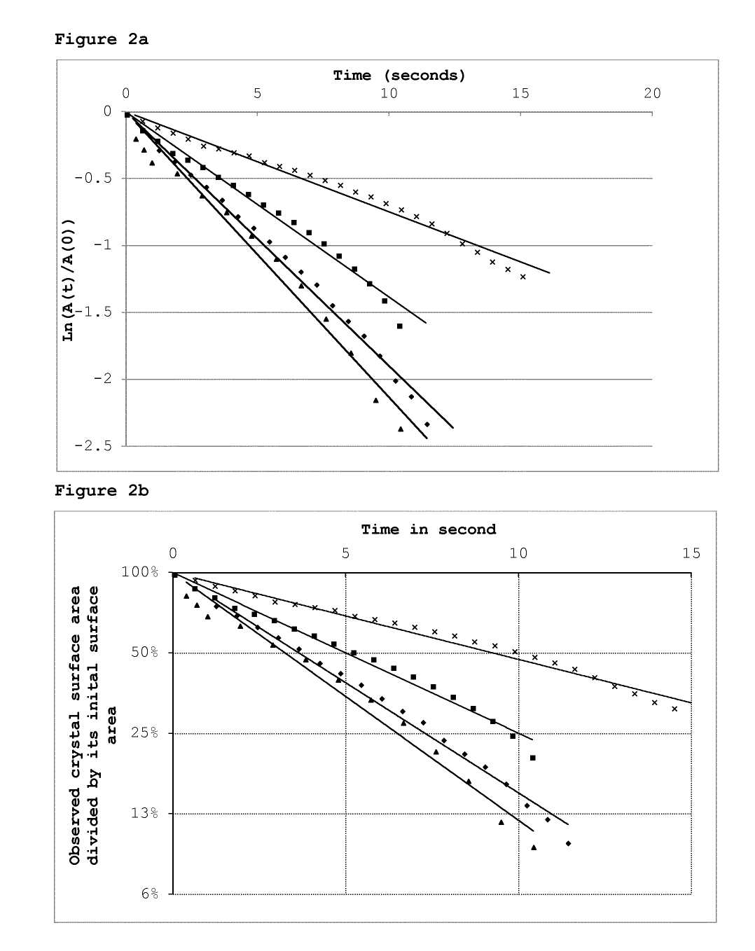

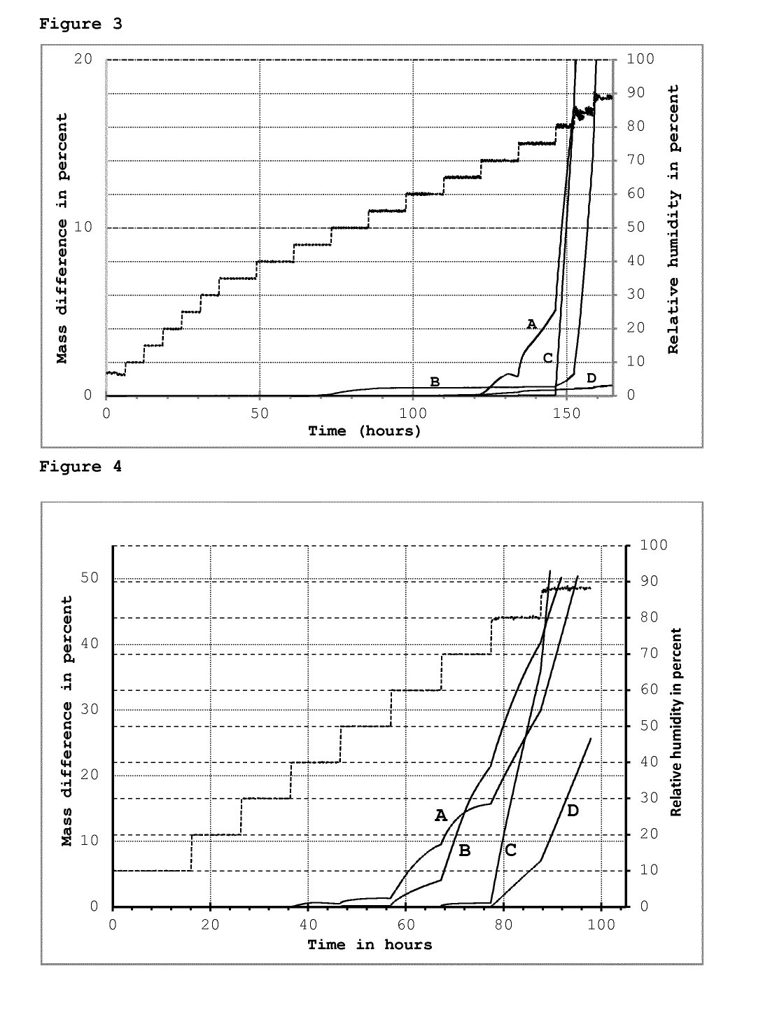

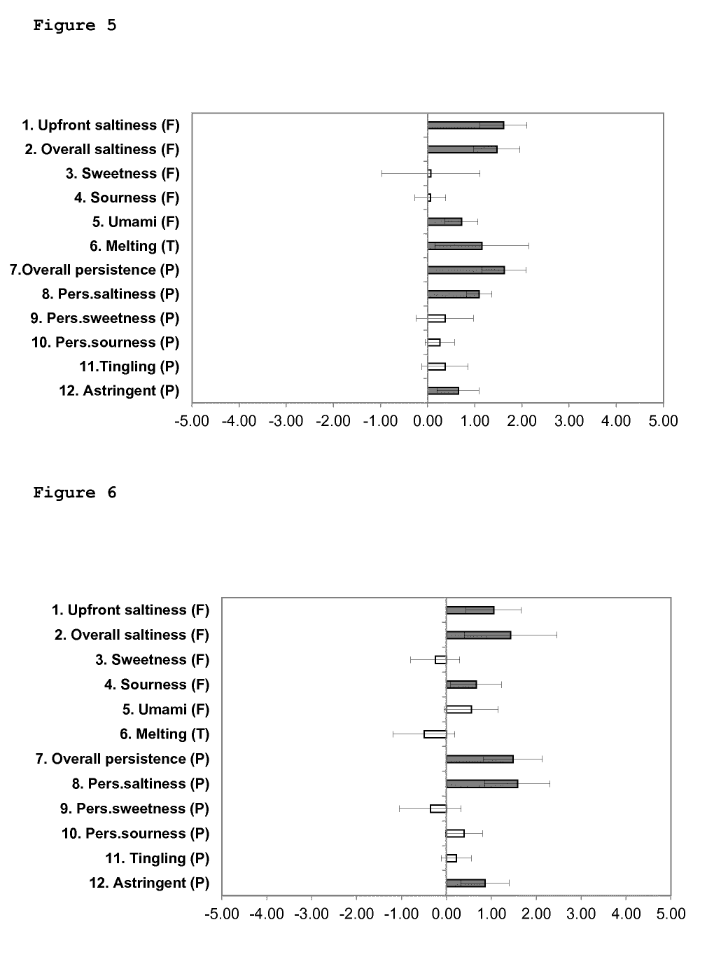

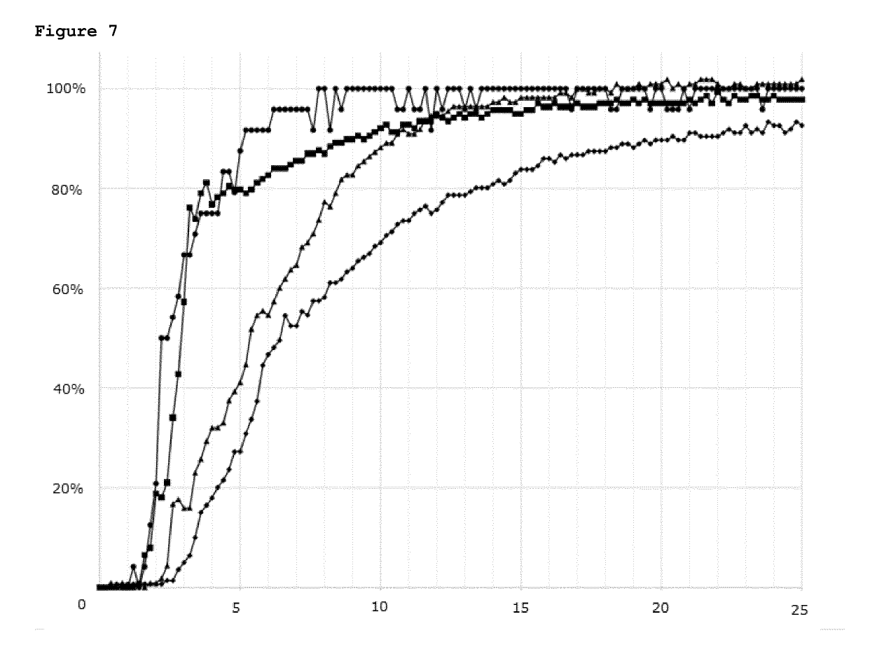

In FIG. 2a, the first order kinetic, is represented:

$$Ln \frac{{A}_{t}}{{A}_{0}} = - k \times t$$

Aₜ: area (μm²) of the crystal at time t (seconds)

A₀: initial area (μm²) of the crystal

t: time (s)

k: constant (s⁻¹)

(Glucose)₂⋅NaCl⋅H₂O co-crystals in water (♦), pure anhydrous Glucose (▪), pure sodium chloride (▴), pure Glucose monohydrate (x). The linear graphs are the corresponding regressions.

In FIG. 2b, the observed crystal surface area divided by its initial surface area is presented in percent over time (s). (Glucose)₂⋅NaCl⋅H₂O co-crystals in water (♦), pure anhydrous Glucose (▪), pure sodium chloride (▴), pure Glucose monohydrate (x). The linear graphs are the corresponding regressions.

FIG. 3 shows the dynamic moisture (vapor) sorption behavior of (Glucose)₂⋅NaCl⋅H₂O co-crystals. (Glucose)₂⋅NaCl⋅H₂O (curve B), pure Glucose monohydrate (curve D), pure sodium chloride (curve C), physical mixture of Glucose monohydrate and sodium chloride (curve A).

FIG. 4 shows the dynamic sorption behavior of Ribose⋅sodium chloride co-crystals. Ribose⋅sodium chloride co-crystals (curve B), pure Ribose (curve D), pure sodium chloride (curve C), physical mixture of Ribose and sodium chloride (curve A).

FIG. 5 shows a comparative sensory profile of (glucose)₂⋅NaCl⋅H₂O vs. glucose+NaCl (reference) 12 trained panelists (12 observations)—95% Confidence Interval.

FIG. 6 shows a comparative sensory profile of (ribose)⋅NaCl⋅H₂O vs. ribose+NaCl (reference) 10 trained panelists (10 observations)—95% Confidence Interval.

FIG. 7 shows normalized refractive index (%) versus time (s) for the dissolution of; physical mixture of sucrose and sodium chloride ♦, sucrose⋅NaCl⋅H₂O co-crystal ▪, pure sucrose ▴ and pure NaCl ●.

### DETAILED DESCRIPTION OF THE INVENTION

The present invention provides a nutritional composition comprising carbohydrate⋅sodium chloride salt co-crystals.

“Crystal” or “crystalline material” as used herein is to be understood as a solid material whose constituents are arranged in a regularly ordered pattern that is periodic in three dimensions.

“Co-crystal” according to the present invention is a crystalline structure comprising at least two components in a defined stoichiometric ratio. For instance the components are atoms, ions or molecules.

“Carbohydrate⋅sodium chloride co-crystals” as used herein are to be understood as carbohydrates present in co-crystalline form with sodium chloride, i.e. the crystalline structure comprises a carbohydrate molecule and sodium chloride.

“Dissolution” as used herein means the process by which a solute forms a homogeneous solution in a solvent, e.g. water, ethanol, glycerol, propylene glycol, milk, coffee, tea, juice or saliva.

“Dissolution kinetics” in the sense of the invention is defined as the rate of the physico-chemical process of dissolution, i.e. the speed of dissolution.

“Water activity” or a_{w} is the partial vapor pressure of water in a substance divided by the standard state partial vapor pressure of water. The standard state is the partial vapor pressure of pure water at the same temperature. a_{w}=p/p₀, where p is the vapor pressure of water in the substance, and p₀ is the vapor pressure of pure water at the same temperature.

“Food product” in the present context means a substance that serves as food or can be prepared as food, i.e. a substance that can be metabolized by an organism resulting in energy and/or tissue.

In the context of the present invention, the term “functional food product” means a food product providing an additional health-promoting or disease-preventing function to the individual. Any kind of known biologically-active compound may be added to the food product of the invention in order to provide additional health benefits.

“Dairy products”, as used herein, are food products produced from animals such as cows, goats, sheep, yaks, horses, camels, and other mammals. Examples of dairy products suitable in the present invention are milk powder, cheese, ice cream, yoghurt, cream cheese, spreads, and confectionery products, e.g. chocolate. Preferably, the dairy product is selected from a low-fat milk, a fat-free milk, a milk product, a milk powder, or a protein powder.

In the present context, a “nutritional supplement” describes a nutritional composition which is provided in addition to a regular diet providing nutrients (macronutrients or micronutrients) or dietary fibers, e.g. micronutrients like certain vitamins, minerals, e.g. macronutrients like fatty acids, amino acids, carbohydrates, protein etc.

A “pet food product” is a nutritional product that is intended for consumption by pets.

A pet or companion animal is an animal selected from dogs, cats, birds, fish, rodents such as mice, rats, and guinea pigs, rabbits, etc.

“Carrier” as used herein is to be understood as material to which substances are incorporated to improve the delivery of specific matter. Carriers may be used in drug delivery systems to prolong actions of pharmaceuticals, decrease their metabolism or tailor their release profile. Carriers may also be used for flavors in order to have the desired flavor release profile or in order to allow appropriate dosing in a food production context.

“Stabilizer” in the present context means a substance that maintains something, e.g. a food or beverage, in a stable or constant state, e.g. with regard to their pH or texture or moisture content or to prevent oxidative degradation.

“Filler” in the present sense relates to a substance, which is added to a composition to increase weight or size or to fill space (volume). Fillers (bulking agents) may be used in nutritional, e.g. a food or instant beverage product, as well as in cosmetic products, such as skin care formulations.

Carbohydrate-Sodium Chloride Co-Crystals

The advantageous effects of carbohydrate-sodium chloride co-crystals described in this application are expected to occur with any co-crystal of a carbohydrate and sodium chloride.

Ionic salts, e.g. sodium chloride are held together in the solid state by Coulomb interactions, which determine the overall physico-chemical properties and chemical behavior in general. In contrast, carbohydrates in their solid state are held together mainly by Van-der-Waals interactions and hydrogen-bonding, which render those materials distinctly different in their pure form. Two examples that illustrate this are the different hardness of sugars (organics) versus salts (inorganics) or their largely different melting points.

Co-crystals of sodium chloride with carbohydrates (solvated or not solvated) are particular in that sense, that they are held together in the solid, crystalline state by Coulomb interactions, Van-der-Waals interactions and hydrogen-bonding at the same time. Consequently, their behavior in the solid state differs sharply from their individual pure ingredients. Evidently, this applies to all possible combinations of co-crystalline carbohydrates with sodium chloride and one can generalize that the observed behavior of individual systems applies certainly to the entire range of possible combinations.

It is also envisioned to prepare carbohydrate-sodium chloride co-crystals each containing different carbohydrates and subsequently providing mixtures of these different carbohydrate-sodium chloride co-crystals, for example mixtures of one, two, three or more different carbohydrate-sodium chloride co-crystals.

Further, it is envisioned to prepare carbohydrate-sodium chloride co-crystals containing different carbohydrates, thus providing different carbohydrates in combination with sodium chloride, e.g. mixtures of Glucose and Saccharose or mixtures of Ribose and Lactose.

Preferably, the carbohydrates of the carbohydrate-sodium chloride co-crystal are selected from the group consisting of monosaccharides or disaccharides, mixtures of different monosaccharides, mixtures of different disaccharides, or mixtures of monosaccharides and disaccharides.

Preferably, the monosaccharide is selected from the group consisting of pentoses or hexoses.

The pentose can be selected from the group consisting of Ribose, Arabinose, Lyxose, Xylose, Arabinose, Lyxose, Xylose, Ribulose, Xylulose, Ribulose, Xylulose.

The hexose can be selected from the group consisting of Glucose, Allose, Altrose, Mannose, Gulose, Idose, Galactose, Talose, Psicose, Fructose, Sorbose, or Tagatose.

Preferably the disaccharide is selected from the group consisting of Sucrose, Lactulose, Lactose, Maltose, Trehalose, Cellobiose, Chitobiose, Kojibiose, Nigerose, Isomaltose, beta,beta-Trehalose, alfa,beta-Trehalose, Sophorose, Laminaribiose, Gentiobiose, Turanose, Maltulose, Isomaltulose Palatinose, Gentiobiulose, Mannobiose, Melibiose, Melibiulose, Rutinose, Rutinulose, or Xylobiose.

For example the carbohydrate of the carbohydrate-sodium chloride co-crystal may be selected from the group consisting of Ribose, Glucose, Sucrose, Lactose, Maltose, Mannose, Xylose, Rhamnose, Psicose, Fructose and Tagatose.

Especially preferred carbohydrates are selected from the group consisting of Glucose, Ribose, or Sucrose.

“Glucose” in the present sense can be D-Glucose, L-Glucose, α-D-Glucose, β-D-Glucose, α-L-Glucose, β-L-Glucose, D-(+)-Glucose, L-(−)-Glucose, D-(−)-Glucose, L-(+)-Glucose.

“Ribose” in the present sense means D-Ribose, L-Ribose, α-D-Ribose, β-D-Ribose, α-L-Ribose, β-L-Ribose, D-(+)-Ribose, L-(−)-Ribose, D-(−)-Ribose, L-(+)-Ribose.

Thus, preferred carbohydrate-sodium chloride co-crystals are selected from the group consisting of Ribose⋅sodium chloride even more preferred Ribose⋅sodium chloride; (Glucose)₂⋅sodium chloride⋅H₂O, or Sucrose⋅sodium chloride⋅2 H₂O.

Nutritional Composition

In the present context, a “nutritional composition” may be any kind of product that provides a nutritional benefit to an individual and that may be safely consumed by a human or an animal. It is preferably a solid (e.g. powdery) product too. It may be in solid or semi-solid form and may comprise one or more macronutrients, micronutrients, dietary fibers, food additives, water, etc., e.g. a protein source, a fat source, a carbohydrate source, polyphenols, bioactives, vitamins and minerals. The nutritional composition may also contain antioxidants, stabilizers or emulsifiers.

Advantageously, the nutritional composition is present in dry or powdery form.

Preferably, the present invention relates to nutritional compositions comprising a desired amount of carbohydrate⋅sodium chloride salt co-crystals to provide the consumer with a sufficient amount of sodium chloride or a sufficient amount of carbohydrate respectively. Thus, the nutritional compositions comprise carbohydrate⋅sodium chloride co-crystals in a concentration of 0.01-100 wt %, preferably in a concentration of 1-70 wt %, more preferably in a concentration of 5-60 wt % based on the total weight of the composition. In a particularly preferred embodiment, the composition comprises carbohydrate⋅sodium chloride co-crystals in a concentration of 10-50 wt %, more preferably in a concentration of 10-20 wt % based on the total weight of the composition.

Optionally, the carbohydrate⋅sodium chloride co-crystals are present in the nutritional or pharmaceutical compositions according to the invention in a concentration of 0.01-5 wt %, preferably in a concentration of 0.1-3 wt %, more preferably in a concentration of 1-2 wt % based on the total weight of the composition.

Carbohydrate⋅sodium chloride co-crystals provide a readily dissolvable form of sodium chloride and of the carbohydrate respectively. In comparison to their constituents in a physical mixture, carbohydrate⋅sodium chloride co-crystals dissolve considerably faster in a solvent.

Surprisingly, sensory testing also confirmed that carbohydrate⋅sodium chloride salt co-crystals taste saltier than a mere physical mixture of the constituents. Thus, a reduced amount of sodium chloride in the form of a carbohydrate⋅sodium chloride co-crystal can provide the same sensory experience as a larger amount of sodium chloride in a physical mixture of carbohydrate and sodium chloride. This makes the carbohydrate⋅sodium chloride co-crystals particularly useful for reducing the amount of sodium chloride in nutritional products in the presence of carbohydrates.

The dissolution kinetics of carbohydrate⋅sodium chloride co-crystals in nutritional compositions are improved compared to a physical mixture, i.e. a significantly shorter amount of time is required for complete dissolution.

On a technical scale, pure sodium chloride is characterized by a low flowability, which renders handling and dosage difficult. While simple table salt is prone to caking and therefore enriched with flowing or anti-caking agents such as silica or magnesium salts, (or requires the addition of rice grains to absorb humidity over extended storage periods in table top dispensers) compositions comprising the carbohydrate⋅sodium chloride co-crystals providing sodium chloride in co-crystalline form combined with a carbohydrate are characterized by good flowability resulting in easier handling, storage and dosage without the need of additional flowing agents.

Additionally, when present in the co-crystalline form instead of a mere physical mixture, a lower amount of sodium chloride can be applied in nutritional compositions for achieving the desired salty taste.

The carbohydrate⋅sodium chloride co-crystals may be present in hydrated or anhydrous form.

Carbohydrate⋅sodium chloride co-crystals in hydrated or non-hydrated form may be prepared from solution by direct crystallization, e.g. by solvent evaporation, slow cooling of a supersaturated solution, seeding processes, addition of an anti-solvent, ultrasound-assisted crystallization etc. Alternatively, the co-crystals may be prepared by mechanical processes such as grinding, ball milling of a mixture etc.

The individual constituents of the respective co-crystal are mixed in the required molar ratio and treated mechanically in standard micronization equipment as for example ball mills, disc mills, planetary ball mills etc. for a certain amount of time. Optionally, a liquid can be added to allow for liquid-assisted grinding (LAG) or formation of stoichiometric solvates, e.g. hydrates or ethanolates.

Optionally, the desired co-crystals can also be produced by established and industrialized techniques as spray-drying, atomization, freeze-drying, granulation, twin-screw extrusion, roller-compaction, compression or in certain cases by straightforward mechanical mixing/blending.

The nutritional compositions according to the invention may optionally comprise hydrated or non-hydrated carbohydrate⋅sodium chloride salt co-crystals, depending on their preparation process. If not co-crystallized from water, which may result in hydrated carbohydrate⋅sodium chloride co-crystals, but with alcohols or other food-grade solvents such as ethanol, isopropanol, propanol, propylene glycol, acetone or ethyl acetate, non-hydrated carbohydrate⋅sodium chloride co-crystals may be obtained.

Generally, the nutritional composition as used herein may be a food product, a functional food product, a frozen food, a ready-meal, a microwaveable product, an individually portioned product, a dairy product, a confectionery product, a culinary product, an instant food product for providing a beverage, a nutritional supplement, or a pet food product.

Preferably, the food product is a pizza, a savory turnover, a bread, a cookie, a pasta, a gluten-free pasta, a gluten-free dough, a dough, a pizza dough, a chilled dough product, a frozen dough product, a mayonnaise, a spread, a thickener, a pretzel, a snack product, a potato chip, a tortilla, a bouillon cube, a cooking aid, a tastemaker, a gellified concentrated bouillon, an instant soup, a topping, or salt replacer, a seasoning mix, a flavor or a fortifying mix or a mineral mix. For example the food product may be a bouillon cube, a gellified concentrated bouillon, a cooking aid or a tastemaker.

The carbohydrate⋅sodium chloride co-crystal might be mixed into the food product or be applied on the outside of the food product without substantially intruding into the food product (e.g. the granules of carbohydrate⋅sodium chloride co-crystal on the surface of a pizza, a savory turnover, a pretzel, a pasta or as a seasoning/topping).

The co-crystals of the invention can be applied to any food product that contains sufficiently low humidity to prevent the dissolution of the co-crystal prior to contact of the co-crystal with the saliva of a consumer. In particular, it is preferred that the food products exhibit a rather low water activity (a_{w}).

Additionally, the co-crystals of the present invention can be encapsulated in order to prevent dissolution of the co-crystal prior to contact of the co-crystal with the saliva of a consumer.

Surprisingly, the shelf life of a composition comprising carbohydrate⋅sodium chloride co-crystals is significantly prolonged in comparison to compositions comprising its individual constituents in a physical mixture (dry mix). Carbohydrate⋅sodium chloride co-crystals unexpectedly show an improved moisture tolerance as compared to compositions comprising its individual constituents.

Advantageously, carbohydrate⋅sodium chloride co-crystals are rapidly dissolvable in the consumer's saliva, resulting in a homogeneous, lump-free, salty tasting solution, which delivers the desired saltiness without gritty sensations.

Use

The present invention is further directed towards the use of carbohydrate⋅sodium chloride co-crystals for preparing a nutritional composition.

In nutritional compositions carbohydrate⋅sodium chloride co-crystals according to the invention are especially advantageous, since fast and complete dissolution in the presence of carbohydrates as well as high availability of sodium chloride results in a unexpectedly strong salty taste as compared to a physical mixture.

Moreover, carbohydrate⋅sodium chloride co-crystals are characterized by a specific volume, which renders them suitable materials as carriers, fillers, bulking agents or stabilizers in nutritional compositions. E.g. carbohydrate⋅sodium chloride co-crystals may be used as bulking agent when other ingredients such as fat, sugars, or proteins are reduced. Additionally, carbohydrate⋅sodium chloride co-crystals may be used as bulking agents in cosmetic preparations.

In the sense of the present invention, carriers may further include starches, modified starches, milk powders, carbohydrates, sugars, proteins, amino acids, fats, sweeteners, emulsifiers etc.

Process

The co-crystals as defined above may be obtained by co-crystallization, by seeding a supersaturated solution with a seeding crystal, by ultrasound-assisted crystallization, by ball milling the constituents of the co-crystal, by atomization or spray-drying of solutions of a carbohydrate and sodium chloride, by twin-screw extrusion of a carbohydrate with sodium chloride, by freeze-drying a solution of a carbohydrate and sodium chloride, by roller-compaction of a carbohydrate with sodium chloride.

In particular, carbohydrate⋅sodium chloride co-crystals may be obtained by conducting co-crystallization in a solution or slurry mixed from the two components carbohydrate and sodium chloride.

Alternatively, carbohydrate⋅sodium chloride co-crystals may be prepared by grinding, e.g. manually with mortar and pestle, a ball mill or a vibratory mill. Optionally, liquid-assisted grinding may be performed to produce carbohydrate⋅sodium chloride co-crystals. Also, a preparation by simple mechanical mixing and subsequent storage at a certain relative humidity can be envisioned.

Carbohydrate⋅sodium chloride co-crystals may preferably be prepared by cooling a molten mixture, optionally a saturated solution of the two components, i.e. a carbohydrate and sodium chloride, resulting in co-crystal formation by precipitation.

Carbohydrate⋅sodium chloride co-crystals may preferably be prepared by adding an antisolvent to a saturated solution of the two components, i.e. a carbohydrate and sodium chloride, resulting in co-crystal formation by precipitation, as the antisolvent will generate supersaturation and cause nucleation of the co-crystalline phase.

Preferably, the added antisolvent is a food-grade solvent. More preferably, the added antisolvent is a food-grade solvent, e.g. ethanol, isopropanol, propanol, propylene glycol, acetone or ethyl acetate.

Optionally, preparation of carbohydrate⋅sodium chloride co-crystals by cooling of a molten mixture or a saturated solution of carbohydrate and sodium chloride may require seeding with a seeding co-crystal.

In the present context, “seeding” means the use of a small quantity of a co-crystal, i.e. a seeding co-crystal, from which larger co-crystals of the identical crystalline phase are grown. Seeding is necessary to avoid spontaneous nucleation of undesired phases and therefore allows for a controlled production process of the desired material.

The seeding crystal may be a carbohydrate⋅sodium chloride co-crystal or may be a co-crystal which is isostructural to the desired carbohydrate⋅sodium chloride co-crystal. In the context of the present invention, two crystals are said to be isostructural if they have the same structure, but not necessarily the same cell dimensions nor the same chemical composition, and with a ‘comparable’ variability in the atomic coordinates to that of the cell dimensions and chemical composition. For example, sucrose⋅NaCl⋅2 H₂O co-crystals are isostructural with sucrose⋅NaBr⋅2 H₂O co-crystals, sucrose⋅NaF⋅2 H₂O co-crystals, sucrose⋅LiCl⋅2 H₂O co-crystals, sucrose⋅LiBr⋅2 H₂O co-crystals, sucrose⋅LiF⋅2 H₂O co-crystals, sucrose⋅KCl⋅2 H₂O co-crystals, sucrose⋅KBr⋅2 H₂O co-crystals and sucrose⋅KF⋅2 H₂O co-crystals. The use of isostructural seeding crystals is particular useful when the desired carbohydrate⋅sodium chloride co-crystal is difficult to precipitate from solution without seeding.

The seeding crystal may be prepared by co-crystallizing the carbohydrate and sodium chloride by cooling a molten mixture or a saturated solution of a carbohydrate and sodium chloride.

Optionally the preparation of a saturated solution of carbohydrate and sodium chloride is followed by slow evaporation.

In the case of isostructural seeding crystals, the seeding crystals may be prepared by any techniques known in the art, for example they may be prepared by co-crystallizing a carbohydrate and a salt by cooling a molten mixture or a saturated solution of a carbohydrate and a salt.

In a specific embodiment the process for preparing carbohydrate⋅sodium chloride seeding crystals comprises the preparation of a mixture or solution, optionally a saturated solution, comprising carbohydrate and sodium chloride at a temperature of 15-75° C., optionally at a temperature of 20-60° C. Optionally, the process further comprises addition of ethanol to the solution. Optionally, the process further comprises a cooling step to a temperature of 5-30° C., preferably to a temperature of 10-25° C. Precipitated co-crystals can then be isolated, washed, e.g. with cold (8-10° C.) ethanol, and dried. Drying of the carbohydrate⋅sodium chloride co-crystal may be carried out under vacuum for 0.5 to 4 hours, preferably 1-2 hours. The obtained carbohydrate⋅sodium chloride co-crystals may be used as seeding crystals, after their phase purity has been checked by appropriate methods, e.g. X-ray diffraction analysis.

In a specific embodiment the process for preparing Ribose⋅sodium chloride seeding crystals comprises the preparation of a mixture or solution, optionally a saturated solution, comprising Ribose and sodium chloride at a temperature of 15-35° C., optionally at a temperature of 20-30° C. The process further comprises addition of ethanol to the solution. Precipitated co-crystals can then be isolated, washed, e.g. with cold (8-10° C.) ethanol, and dried. Drying of the carbohydrate⋅sodium chloride co-crystal may be carried out under vacuum for 0.5 to 4 hours, preferably 1-2 hours. The obtained Ribose ⋅sodium chloride co-crystals may be used as seeding crystals, after their phase purity has been checked by appropriate methods, e.g. X-ray diffraction analysis.

An alternative process for preparing Ribose⋅sodium chloride seeding crystals includes the preparation of a mixture or solution comprising Ribose and sodium chloride at a temperature of 15-35° C., preferably at a temperature of 20-30° C. for 20 to 40 minutes, preferably for 25 to 35 minutes and heating the solution to a temperature of 55-70° C. for 90 minutes to 150 minutes, preferably to a temperature of 60-65° C. for 90 minutes to 150 minutes, preferably to 105 to 135 minutes, to obtain a homogeneous solution. Said homogeneous solution is then cooled to a temperature of 5-15° C., preferably to 8-12° C. allowing co-crystal formation. Precipitated co-crystals can then be isolated, washed, e.g. with cold (8-10° C.) ethanol, and dried. Drying of the Ribose⋅sodium chloride co-crystals may be carried out at under vacuum for 0.5 to 4 hours, preferably 1-2 hours. The obtained Ribose ⋅sodium chloride co-crystals may be used as seeding crystals, after their phase purity has been checked by appropriate methods, e.g. X-ray diffraction analysis.

In another specific embodiment the process for preparing (Glucose)₂⋅NaCl H₂O seeding crystals comprises the preparation of a mixture or solution, optionally a saturated solution, comprising sodium chloride at a temperature of 15-35° C., optionally at a temperature of 20-30° C. The process further comprises heating the solution to 50-70° C., preferably to 55-65° C., and then adding Glucose. The solution may then be cooled to 20-30° C. until crystal precipitation. Precipitated co-crystals can then be isolated, washed, e.g. with cold (8-10° C.) ethanol, and dried. Drying of the co-crystals may be carried out at under vacuum for 0.5 to 4 hours, preferably 1-2 hours. The obtained co-crystals may be used as seeding crystals, after their phase purity has been checked by appropriate methods, e.g. X-ray diffraction analysis.

An alternative process for preparing (Glucose)₂⋅NaCl⋅H₂O seeding crystals comprising the preparation of a suspension of Glucose in water at a temperature of 15-25° C. Sodium chloride may then be added stepwise and the solution may be heated to a temperature of 50-70° C. to obtain a colorless and homogeneous solution. The heating step may be followed by cooling the solution to 35-45° C. allowing co-crystal precipitation. Precipitated co-crystals can then be isolated, washed, e.g. with cold (8-10° C.) ethanol, and dried. Drying of the co-crystals may be carried out at under vacuum for 0.5 to 4 hours, preferably 1-2 hours. The obtained co-crystals may be used as seeding crystals, after their phase purity has been checked by appropriate methods, e.g. X-ray diffraction analysis.

In particular, carbohydrate⋅sodium chloride salt co-crystals may be prepared by a process comprising adding the two components, i.e. carbohydrate and a sodium chloride in a concentration range of 0.1:2.0 parts by weight (or 0.5:1.5 by mole) to 2.0:0.1 parts by weight (or 1.5:0.5 by mole), optionally in a concentration range of 0.2:1.2 parts by weight (or 0.8:1.2 by mole) to 1.2:0.2 parts by weight (or 1.2:0.8 by mole), optionally in a concentration range of 1:1 parts by weight, to 1 to 0.5 parts of water, optionally to 1 to 0.6 parts of water, optionally to 1 to 0.8 part of water at 50-100 rpm.

Seeding crystals obtained by a co-crystallization process may subsequently be used for preparing larger amounts of pure carbohydrate⋅sodium chloride co-crystals.

Carbohydrate⋅sodium chloride co-crystals may be prepared by cooling a molten saturated solution of the two components, i.e. carbohydrate and sodium chloride, using a seeding crystal and allowing precipitation of co-crystals.

In a preferred embodiment the process for preparing carbohydrate⋅sodium chloride co-crystals comprises the steps of preparing a solution, optionally a saturated solution, comprising sodium chloride and carbohydrate at a temperature of 55-65° C., cooling the solution to 15-35° C., adding a carbohydrate⋅sodium chloride co-crystal as a seeding crystal and allowing co-crystal formation by precipitation. Carbohydrate⋅sodium chloride co-crystals may be isolated, optionally by filtration or centrifugation.

In a particularly preferred embodiment of the invention, the process for carbohydrate⋅sodium chloride co-crystal preparation comprises the steps of adding carbohydrate and sodium chloride in a concentration range of 0.1:2.0 parts by weight (or 0.5:1.5 by mole) to 2.0:0.1 parts by weight (or 1.5:0.5 by mole), optionally in a concentration range of 0.2:1.2 parts by weight (or 0.8:1.2 by mole) to 1.2:0.2 parts by weight (or 1.2:0.8 by mole), optionally in a concentration range of 1:1 parts by weight, to 1 to 0.5 parts of water, optionally to 1 to 0.6 parts of water, optionally to 1 to 0.8 part of water at 50-100 rpm. The suspension is stirred at 55-65° C. and 50-100 rpm for 10-90 minutes, cooled to 35-40° C. and seeding crystals (carbohydrate⋅sodium chloride co-crystals) are added. Co-crystals may be isolated by filtering the suspension and washing the isolated co-crystals with cold ethanol (8-10° C.) at room temperature (20-25° C.). Isolated co-crystals may then be dried at 15-45° C. under vacuum for 1-3 hours and at 15-25° C. without vacuum for 30-60 hours.

In an embodiment of the invention the process for preparing carbohydrate⋅sodium chloride co-crystals comprising the steps of: a) preparing a saturated (for example supersaturated) solution comprising a sodium chloride and carbohydrate, b) adding a seeding crystal of carbohydrate⋅sodium chloride co-crystal or a co-crystal isostructural with a carbohydrate⋅sodium chloride, c) allowing the formation of crystal, d) isolating the obtained crystals.

The preparation of the saturated solution in the process of the invention may comprise the steps of preparing a solution comprising a sodium chloride and carbohydrate at a temperature of 15-75° C. and cooling the solution to 25-40° C.

As described above, sucrose⋅NaCl⋅2H₂O co-crystals are isostructural with sucrose⋅NaBr⋅2H₂O co-crystals. Sucrose⋅NaBr⋅2H₂O sodium co-crystals have been found by the inventors to efficiently seed the crystallization of sucrose⋅NaCl⋅2H₂O co-crystals. In a process for preparing carbohydrate⋅sodium chloride co-crystals according to the invention wherein the carbohydrate⋅sodium chloride co-crystals are sucrose⋅sodium chloride co-crystals; the process may comprise the steps of: a) preparing a saturated (for example supersaturated) solution of sodium chloride and sucrose, b) adding a seeding crystal of sucrose⋅sodium bromide, c) allowing the formation of crystal, d) isolating the obtained crystals. A portion of the co-crystals so obtained may be used to seed a further saturated solution of sucrose and NaCl. After repeating this process a number of times the NaBr content is reduced to the point where effectively no sucrose⋅NaBr co-crystals remain in the obtained crystals. Accordingly, in a process for preparing carbohydrate⋅sodium chloride co-crystals according to the invention wherein the carbohydrate⋅sodium chloride co-crystals are sucrose⋅sodium chloride co-crystals; the process may comprise the steps of: a) preparing a saturated (for example supersaturated) solution of sodium chloride and sucrose, b) adding a seeding crystal of sucrose⋅sodium bromide, c) allowing the formation of crystal, d) isolating the obtained crystals, e) adding at least some of the obtained crystals to a further saturated solution of sodium chloride and sucrose and allowing the formation of crystals.

Nutritional composition comprising carbohydrate⋅sodium chloride co-crystals may be prepared by adding nutrients, e.g. carbohydrates, proteins, minerals, polyphenol or fat, or a pharmaceutically active ingredient to the carbohydrate⋅sodium chloride co-crystals.

### EXAMPLES

### Example 1a

Preparation of Seeding Crystals (D-(−Ribose)⋅Sodium Chloride Co-Crystals):

In a thermostatted, double-jacketed 50 mL glass reactor with a magnetic stirrer bar, 2.0 g of D-(−)-Ribose and 0.8 g of sodium chloride were added to 2.9 mL of water at 25° C. (300 rpm). After 90 minutes the starting materials were completely dissolved and the stirring was stopped. To this mixture, 19.2 mL of ethanol were slowly added over a period of 90 minutes. After one day crystals had started to form and crystal growth was allowed for one more day. Subsequent filtration was the same as described below. The washing was performed with 10 mL of ethanol and the product was dried one hour under vacuum.

1.0 g of co-crystalline D-(−)-Ribose⋅NaCl were obtained as a white powder (yield: 37%) and used as seeding crystals for all the optimization trials. The phase identity and purity were confirmed via powder X-ray diffraction methods.

### Example 1b

Preparation of Seeding Crystals of D-(-Ribose)⋅Sodium Chloride Co-Crystals:

In a thermostatted, double-jacketed 250 mL glass reactor with a magnetic stirrer bar, 50.0 g of D-(−)-Ribose and 19.4 g of sodium chloride were added to 71.4 mL of water and 114 mL of ethanol at 25° C. (300 rpm). After 30 minutes the starting materials were not completely dissolved and the temperature was heated up to 62° C. After two hours, a homogenous solution was obtained and the temperature was cooled down to 10° C. which allowed the solution to start crystallizing. Crystal growth was allowed for twenty hours. Subsequent filtration was performed as described in Example 2. The washing was performed with 60 mL of cold ethanol and the product was dried one hour under vacuum. 25.5 g of co-crystalline D-(−)-Ribose⋅NaCl were obtained as a white powder (yield: 37%) and used as seeding crystals for all the optimization trials. The phase identity and purity were confirmed via powder X-ray diffraction methods.

### Example 2a

Synthesis of Co-Crystalline D-(−)-Ribose⋅NaCl:

160 mL of ethanol and 100 mL of water were placed at room temperature (Tset=25° C.) in a 1 liter double-jacketed, thermostatted glass reactor equipped with overhead stirring, internal temperature control and a water condenser. While stirring (200 rpm) 70 g of D-(−)-Ribose were slowly added over a period of 5 minutes. When the addition was complete a suspension was obtained at 17° C. After stirring (200 rpm) for two more minutes, a yellow solution was obtained at 19° C. (Tset=25° C.). Then, 27 g of sodium chloride were added stepwise over a period of 3 minutes. In order to obtain a homogeneous solution, the temperature was set to 55° C. and after one hour of continued stirring at 200 rpm, a homogeneous solution was obtained (internal temperature 52° C.). Afterwards the external temperature was set to 30° C. and the solution cooled within 65 minutes to 30° C. At this point, 10.0 mg of the seeding crystals prepared according to the method of example 1 were carefully added to the solution and the stirring rate was reduced to 100 rpm for 10 minutes. Crystallization occurred within these minutes (formation of a suspension) and afterwards the mechanical stirring was increased to 100 rpm in order to avoid any sedimentation in the reactor. The temperature was set to 13° C. and the suspension cooled down. In total, the crystallization took 6 hours since the addition of the seeding crystals. Stirring was halted and the suspension subsequently filtered over filter paper under reduced pressure. The isolated crystals were washed twice with 40 mL of ethanol at room temperature. Remaining humidity was removed from the solid product at 30° C. under vacuum for 15 hours (70 mPa). 22.7 g of the co-crystalline D-(−)-Ribose⋅NaCl were obtained as a white powder (yield: 24%). The co-crystalline material was stored in tightly closed glass containers at ambient temperature.

### Example 2b

Synthesis of Co-Crystalline D-(−)-Ribose⋅NaCl:

684 mL of ethanol and 428 mL of water were placed at 30° C. in a 1.2 liter double-jacketed, thermostatted glass reactor equipped with overhead stirring, internal temperature control and a water condenser. While stirring (100 rpm) 300 g of D-(−)-Ribose were slowly added over a period of 10 minutes. When the addition was complete a suspension was obtained at 22° C. Then, 116 g of sodium chloride were added stepwise. In order to obtain a homogeneous solution, the temperature was set to 72° C. and after two hours of continued stirring at 100 rpm, a homogeneous solution was obtained (internal temperature 72° C.). Afterwards the external temperature was set to 30° C. and the solution cooled within 45 minutes to 30° C. At this point, 10 mg of the seeding crystals prepared according to the method of example 1 were carefully added to the solution and the stirring rate was reduced to 80 rpm. Crystallization occurred within these minutes (formation of a suspension). The temperature was set to 10° C. and the suspension cooled down. In total, the crystallization took 15 hours since the addition of the seeding crystals. Stirring was halted and the suspension subsequently filtered over a glass frit under reduced pressure (Borosilicat glass: 3.3; Porosity: 2; 600 mPa; Büchi Vacuum Pump V-700). The isolated crystals were washed with 120 mL of cold ethanol at room temperature. Remaining humidity was removed from the solid product at 40° C. under vacuum for 2 hours (20 mPa). 157.8 g of the co-crystalline D-(−)-Ribose⋅NaCl were obtained as a white powder (yield: 38%). The co-crystalline material was stored in tightly closed glass containers at ambient temperature.

### Example 3a

Synthesis of Seeding Crystals (Glucose)₂⋅NaCl⋅H₂O

In a thermostatted, double-jacketed 200 mL glass reactor with a magnetic stirrer bar, 2.9 g of sodium chloride were added to 10 mL water at 25° C. (200 rpm). The mixture was heated up to 60° C. over a period of 10 minutes and 20 g of alpha-D-(+)-Glucose monohydrate were added. After 16 minutes, a colorless and homogeneous solution was obtained. The temperature was set to 25° C., which allowed for the spontaneous formation of crystals. The temperature was decreased to 20° C. and the crystal growth was allowed to continue for one hour at 150 rpm. The filtration, washing and drying steps were the same as described below for the optimized protocol. 3.0 g of co-crystalline (Glucose)₂⋅NaCl⋅H₂O were obtained as white powder (yield: 12%) and used as seeding crystals for all the optimization trials. The identity and phase purity of the obtained material was confirmed by standard X-ray diffraction methods and comparison with reference diffractograms from the literature.

### Example 3b

Synthesis of Seeding Crystals of (α-D-Glucose)₂⋅NaCl⋅H₂O

200 mL of ethanol and 128 mL of water were placed at room temperature (Tset=25° C.) in a 1.2 liter double-jacketed, thermostatted glass reactor equipped with overhead stirring, internal temperature control and a water condenser. While stirring (70 rpm) 200 g of α-D-Glucose were slowly added over a period of 5 minutes. When the addition was complete a suspension was obtained at 20° C. Then, 44 g of sodium chloride were added stepwise. The mixture was heated up to 65° C. over a period of 10 minutes. After 20 minutes, a colorless and homogeneous solution was obtained. The temperature was set to 40° C., which allowed for the spontaneous formation of crystals. The temperature was maintained at 40° C. and the crystal growth was allowed to continue for three hours at 50 rpm. The filtration, washing and drying steps were the same as described below for the optimized protocol. 69 g of co-crystalline (α-D-Glucose)₂⋅NaCl⋅H₂O were obtained as white powder (yield: 31%) and used as seeding crystals for all the optimization trials. The identity and phase purity of the obtained material was confirmed by standard powder X-ray diffraction methods and comparison with the reference diffractogram from the literature.

### Example 4a

Synthesis Via Direct Crystallization (Glucose)₂⋅NaCl⋅H₂O

98 mL of water were placed at room temperature (Tₛₑₜ=25° C.) in a 500 mL double-jacketed, thermostatted glass reactor equipped with overhead stirring, internal temperature control and a water condenser. While stirring (150 rpm) 14.7 g of Sodium Chloride were added over a period of 1 minute. A colorless solution was obtained and 155 mL of ethanol were added over a period of two minutes. Then, the temperature was set to 55° C. and 100 g of alpha-D-(+)-Glucose monohydrate were added stepwise over a period of 8 minutes under constant stirring (200 rpm). A suspension was obtained and the internal temperature decreased to 48° C. (Tₛₑₜ=55° C.). After 17 minutes a colorless and homogeneous solution was obtained. Afterwards the temperature was set to 30° C. and the solution slowly cooled to 28° C. within 50 minutes. At this point, 10 mg of seeding crystals prepared according to the method of example 4 were carefully added to the solution and the stirring rate was reduced to 100 rpm for 5 minutes. Crystallization occurred within these minutes (formation of a suspension) and stirring was increased in order to avoid any sedimentation in the reactor. After 5 more minutes, the temperature was set to 3° C. for 100 minutes. In total, the crystallization took 180 minutes since the addition of the seeding crystals. Finally, stirring was halted and the suspension subsequently filtered over a glass frit under reduced pressure (Borosilicat glass: 3.3; Porosity: 2; 600 mPa; Büchi Vacuum Pump V-700). The isolated crystals were washed with 40 mL of cold ethanol at room temperature. The solid product was dried at 30° C. under vacuum for 2 hours (Wisag drying oven; 12 mPa) and 29.9 g of the co-crystalline (Glucose)₂⋅NaCl⋅H₂O were obtained as a white powder (yield: 24%). The crystalline material was stored in tightly closed plastic or glass containers at ambient temperature.

### Example 4b

Synthesis Via Direct Crystallization of (α-D-Glucose)₂⋅NaCl⋅H₂O

400 mL of water and 571 mL of ethanol were placed at room temperature (Tₛₑₜ=25° C.) in a 1.2 L double-jacketed, thermos-statted glass reactor equipped with overhead stirring, internal temperature control and a water condenser. While stirring (100 rpm) 132 g of Sodium Chloride and 600 g of alpha-D-(+)-Glucose monohydrate were added over a period of 15 minutes. Then, the temperature was set to 75° C. and a colorless solution was obtained after 75 minutes. Afterwards the temperature was decreased to 45° C. and the stirring rate was set to 40 rpm. The time to reach this temperature was one hour. At this point, 10 mg of seeding crystals prepared according to the method of example 3 were carefully added to the solution for 5 minutes. Crystallization occurred within these minutes (formation of a suspension) and the mixture was maintained under these conditions over 13 hours. Finally, stirring was halted and the suspension subsequently filtered over a glass frit under reduced pressure (Borosilicat glass: 3.3; Porosity: 2; 600 mPa; Büchi Vacuum Pump V-700). The isolated crystals were washed with 100 mL of cold ethanol at room temperature. The solid product was dried at 40° C. under vacuum for 7 hours (Rotavap; 20 mPa) and 184.2 g of the co-crystalline (α-D-Glucose)₂⋅NaCl⋅H₂O were obtained as a white powder (yield: 28%). The crystalline material was stored in tightly sealed aluminum bags at ambient temperature.

### Example 5

Mechanochemical Synthesis (Glucose)₂⋅NaCl⋅H₂O

1.08 g Glucose anhydrous (6 mmol), 175 mg Sodium Chloride (3 mmol) and 54 mg Milli-Q Water (3 mmol) were placed in a Retsch MM400 vibratory ball mill and ball-milled at room temperature at a frequency of 5 Hz with one INOX steel ball (diameter 20 mm) for 1.5 h to give 1.22 g of the co-crystalline material.

### Example 6

Glucose NaCl Kinetics of Dissolution Via Refractometry

The (Glucose)₂⋅NaCl⋅H₂O co-crystals of Example 3 were tested for their dissolution behavior by refractometry. The equipment used was a RFM300+ refractometer by Bellingham and Stanley. The test samples were added to 60 mL of water, and the dissolution was measured under stirring at 50 rpm using a refractometer with one measurement/second for 50 seconds. Every dissolution experiment was performed three times and the average value was calculated. The particle size was 100-200 μm.

The following samples were tested:

| Sample | Amount |
|---|---|
| (Glucose)₂•NaCl•H₂O co-crystal | 4.19 g |
| NaCl | 0.56 g |
| Glucose monohydrate | 3.80 g |
| Anhydrous Glucose | 3.45 g |
| Physical Mixture of Glucose monohydrate and NaCl | 3.80 g/0.56 g |
| Physical mixture of anhydrous Glucose and NaCl | 3.45 g/0.56 g |

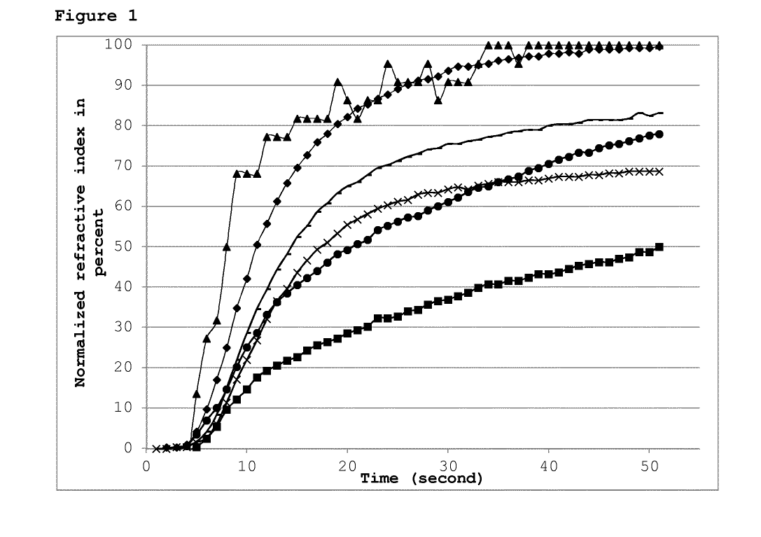

The dissolution kinetics of the samples for up to 50s are presented in FIG. 1.

The following table indicates at which time which degree of dissolution was reached.

| | 10% | 50% | 90% |
|---|---|---|---|
| | dissolution | dissolution | dissolution |
| Sample | reached at [s] | reached at [s] | reached at [s] |
| (Glucose)₂•NaCl•H₂O | 6 | 11 | 25 |
| co-crystal | | | |
| NaCl | 4 | 8 | 29 |
| Glucose monohydrate | 6 | 51 | 214 |
| Anhydrous Glucose | 6 | 17 | 289 |
| Physical Mixture of | 5 | 20 | 73 |
| Glucose monohydrate | | | |
| and NaCl | | | |
| Physical mixture of | 6 | 14 | 103 |
| anhydrous Glucose | | | |
| and NaCl | | | |

The data presented here clearly demonstrates that co-crystalline forms of sodium chloride with carbohydrates, e.g. (Glucose)₂⋅NaCl⋅H₂O or Ribose⋅NaCl do not dissolve faster than pure sodium chloride in water alone (comparing the diamond-shaped curve with the triangle shaped data points)—those two curves are fairly close to each other. However, when food products are consumed very often carbohydrates are already present in the respective food product or are generated via early digestive steps caused by enzymes from saliva. Therefore it is more applicable to compare the dissolution profile of pure NaCl in the presence of respective carbohydrates, as those conditions are closer to the actual in-mouth processes occurring during food consumption; Comparing to pure NaCl dissolving in water alone has limited value. Switching to the according dry-mixes (sodium chloride in a physical mixture with a carbohydrate, e.g. Glucose Monohydrate) shows a different picture (comparing the diamond-shaped curve with the sphere-shaped data points): after 25 seconds, 90% of the co-crystalline material is dissolved, which corresponds very well with the standard residence time in mouth before swallowing, whereas the physical mixture is 90% dissolved only after more than a minute, e.g. 73 seconds. As solely the fraction of sodium chloride can be perceived as salty that is fully dissolved in saliva, the carbohydrate⋅sodium chloride co-crystals taste saltier than their reference physical mixtures when consumed in the solid state.

### Example 7

Dissolution Kinetics Via Microscopic Analysis for (Alpha-D-Glucose)₂⋅NaCl⋅H₂O Co-Crystal

One individual crystal of sodium chloride, Glucose monohydrate, anhydrous Glucose and of (Glucose)₂⋅NaCl⋅H₂O co-crystal prepared according to the method of Example 3 was tested for its dissolution behavior by microscope. The analysis was performed in analogy to the method described by Quilaqueo et al. (“Dissolution of NaCl crystals in artificial saliva and water by video-microscopy”, Food Research International 69, 2015, p. 373-380).

A digital microscope was used to perform video-microscopy on the co-crystals and their respective individual components. Crystal size in general ranged between 100-200 μm. Images were recorded on a DFC450 digital microscope from Leica Microsystems with a high quality 5 Megapixel CCD sensor. The light intensity and contrast were controlled by using a VH-K20 Variable Illumination. The software used to record and analyze the video images was provided by the supplier of the module Leica LAS MultiTime.

One individual crystal specimen of sufficient quality and crystallinity was fixed on the microscope table using double-face adhesive tape. The crystal was fully immersed in 10 μL of water and the video recorded in parallel. The recording was dissected into individual film stills and the remaining crystalline area was determined until complete dissolution occurred using the respective software.

Applying this methodology, a first order kinetic was used to interpret the result:

$$Ln \frac{{A}_{t}}{{A}_{0}} = - k \times t$$

Where Aₜ is the area (μm²) of the remaining solid crystal at a time t (in seconds), A₀ is the initial area (μm²) of the crystal, t is the time (s) and k is the constant (s⁻¹).

The results are presented in FIGS. 2a and b: (Glucose)₂⋅NaCl⋅H₂O co-crystals in water, k=0.19: (♦); pure anhydrous Glucose, k=0.14: (▪); pure sodium chloride, k=0.21: (▴); pure Glucose monohydrate, k=0.08: (x). The linear graphs are the corresponding regressions.

In FIG. 2b, the values were normalized representing the observed crystal surface area divided by its initial surface area in percent over time (s).

From the obtained data, it can be deduced that the pure co-crystal and the pure salt are dissolving faster than pure Glucose monohydrate and the anhydrous Glucose, which is well reflected by their k-values. The co-crystalline salt and the pure salt dissolve roughly at the same speed, whereas the pure sugar in its hydrated or anhydrous form is significantly slower to disintegrate.

### Example 8

Dynamic Moisture Sorption Properties of (Glucose)₂⋅NaCl H₂O Co-Crystal and D-(−)-Ribose⋅NaCl

The dynamic moisture sorption properties of (Glucose)₂⋅NaCl⋅H₂O co-crystal and D-(−)-Ribose⋅NaCl co-crystal were determined (see FIGS. 3 and 4) in comparison to their pure constituents and the respective physical mixture.

The moisture sorption and desorption behavior was recorded on a SPS11-10μ, automated sorption test system, from Projekt Messtechnik. Around 1.2 g of the respective material was submitted to a continuous gas flow of 4000 mL min⁻¹ at constant temperature (25° C.). The gas flow was composed of pure nitrogen and the necessary amount of water to maintain the required humidity. In parallel, mass variations due to the uptake of water were recorded continuously by a microbalance system (SAG285, Mettler-Toledo) with an accuracy of 0.01 mg. Temperature and RH were controlled with an accuracy of 0.1° C. and 0.1%.

The phenomenon of deliquescence lowering can be observed: the physical mixture begins to take up water at around 55% of relative humidity (RH), whereas the pure ingredients alone as well as the co-crystal start at roughly 80% of RH.

### Example 9

Preparation of Tablets for Sensory Evaluation

Tablets for sensory evaluation were prepared using a Romaco Kilian Styl'One single-stroke tablet press. Tablets had a diameter of 8 mm, the NaCl content per tablet was designed to be 25 mg. The tablets were prepared with 3 compressions of 300 ms and an interval of 200 ms. Tablets containing Ribose had a measured thickness of 1.7 mm and an average mass of 93 mg. Tablets containing Glucose had a measured thickness of 3 mm and an average mass of 192 mg.

The powders for preparing the tablets (representing the physical mixture) were assembled by gentle rotational mixing at reduced pressure (ca. 100 g in total mass, 30 min, 750 mPa) of pure Ribose and Sodium Chloride in a one to one molar ratio. In case of the Glucose, an equimolar mixture of pure anhydrous Glucose, Glucose monohydrate and Sodium Chloride was prepared, thus matching the overall molar composition of the co-crystal.

Tablets were stored under nitrogen at ambient temperature. Sodium content was quantified in each composition after tabletting via ²³Na NMR. The tablets were also submitted to powder X-ray diffraction analysis after compaction to ensure that a) no co-crystalline phase had formed or b) the desired co-crystalline phase did not change during the processing.

### Example 10

Sensory Evaluation

The samples were evaluated in the following manner: a forced triangle test was chosen; the panelists received a tray with three tablets presented on plastic plates coded with random 3-digit numbers. The tablets had to be crunched with the front teeth and kept in mouth to dissolve slowly (method 1). Alternatively, tablets had to be crunched with the front teeth and chewed constantly in the mouth until complete dissolution was effected (method 2). Afterwards panelists were asked to select the sample which is perceived different out of the three samples presented. Even if no difference was perceived, they had to select a sample (forced choice procedure).

For the pair Glucose/NaCl (co-crystal vs. dry-mix, method 1), out of 31 answers, 22 were correct, corresponding to a significant difference (alpha risk <2%) in perception. Out of the correct answers, seven panelists found the co-crystal saltier, four said it would dissolver faster, while six panelists stated that the physical mixture would dissolve slower.

For the pair Glucose/NaCl (co-crystal vs. dry-mix, method 2), out of 31 answers, 17 were correct, corresponding to a significant difference (alpha risk <2%) in perception. Out of the correct answers, six panelists found the co-crystal saltier, four said it would dissolver faster, while two panelists stated that the physical mixture would dissolve slower.

For the pair Ribose/NaCl (co-crystal vs. dry-mix, method 2), out of 28 answers, 19 were correct, corresponding to a significant difference (alpha risk <2%) in perception. Out of the correct answers, six panelists found the co-crystal saltier than the dry-mix.

Accordingly, it can be concluded that carbohydrate NaCl co-crystals provide a saltier perception than a mixture of the individual constituents. This makes the co-crystals of the invention particularly useful for seasoning food with a reduced amount of NaCl.

### Example 11

Sensory Profiling

The sensory profile of carbohydrate NaCl co-crystals was compared with that of the equivalent dry mix, for Glucose/NaCl and Ribose/NaCl. Tablets were prepared as in Example 9. Trained panelists were used for the evaluation. The attributes assessed were 1) Upfront saltiness, 2) Overall saltiness, 3) Sweetness, 4) Sourness, 5) Umami, 6) Melting, 7) Overall persistence, 8) Persistent saltiness, 9) Persistent sourness, 10) Tingling and 11) Astringent. The letters after the attributes correspond to the following sensory dimensions: F=Flavour, T=Texture and P=Persistence. Results are shown in FIGS. 5 and 6.

Statistical significance of the differences is visualized on the graphs by displaying the error bars representing the confidence Intervals of the means at a given significance level, for example α=5%. This is possible because the reference (Dry mix) is considered as the baseline zero without any variability. The figure has to be read as follows: If the error bars cross the zero line (=score of the reference), the co-crystal is not significantly different from the reference. If the error bars do not cross the zero line (=score of the reference), the co-crystal is significantly different from the reference. Black bars indicate a significant difference at 95% confidence.

For the (glucose)₂⋅NaCl⋅H₂O co-crystal (FIG. 5), the co-crystal tablet was perceived as significantly saltier than the dry mix tablet (glucose+NaCl) during the consumption (upfront, overall) as well as after the consumption (saltiness persistence, overall persistence). The co-crystal tablet was also perceived as significantly faster “melting” than the dry mix tablet due to faster dissolution of the powder in mouth being clearly perceivable.

For the ribose⋅NaCl co-crystal (FIG. 6), the co-crystal tablet was perceived as significantly saltier than the dry mix tablet (ribose+NaCl) during the consumption (upfront, overall) as well as after the consumption (saltiness persistence, overall persistence).

### Example 12

Synthesis of Crystals of Sucrose⋅NaCl⋅H₂O Using Isostructural Seeding Crystals

Initial Synthesis of Seeding Crystals of the Composition Sucrose⋅NaBr⋅2 H₂O:

11.09 g of (D)-(+)-Sucrose and 5.00 g of Sodium Bromide were dissolved at room temperature in 50 mL of deionized water. The solution was slowly evaporated at room temperature and the remaining syrup was stored at ambient temperature. After a period of several weeks, small crystals appeared that were identical to the system Sucrose⋅NaBr⋅2 H₂O as described by Gilli et al. [C. A. Accorsi, F. Bellucci, V. Bertolasi, V. Ferretti and G Gilli, Carbohydrate Research, 191, 105-116 (1989)] After four weeks, the entire batch had solidified in crystalline form and the obtained material was subsequently used as seeding crystals for the initial seeding of the production of Sucrose⋅NaCl⋅2 H₂O. Phase identity and phase purity of the seeding material were carefully verified using X-ray powder diffraction methods.

Synthesis Via Isostructural Seeding Crystallization:

281 mL of water were placed at room temperature (Tₛₑₜ=25° C.) in a 1.2 L thermostatted glass reactor equipped with mechanical bottom stirring (IKA® 1000 reactor), internal temperature control and a water condenser. While stirring (70 rpm) 102 g of Sodium Chloride and 342 g of (D)-(+)-Sucrose were added over a period of 5 minutes. Next, the temperature was set to 75° C. and a colorless solution was obtained over a period of 45 minutes. Afterwards, the temperature was set to 25° C. and the solution slowly cooled to 25° C. within 105 minutes. At this point, the stirring was reduce to 30 rpm and 100 mg of isostructural Sucrose⋅NaBr⋅2 H₂O were carefully added to the solution. After 16 hours, the temperature was set to 5° C. for one day. In total, the crystallization took 40 hours since the addition of the isostructural seeding crystals. Finally, stirring was halted and the suspension subsequently filtered over a glass frit under reduced pressure (Borosilicat glass: 3.3; Porosity: 3; 600 mPa; Büchi Vacuum Pump V-700). The solid product was dried at 40° C. for 15 hours (Wisag drying oven) and 35.0 g of the co-crystalline Sucrose⋅NaCl⋅2 H₂O were obtained as a white powder (yield: 7%). The crystalline material was stored in tightly closed aluminium containers at ambient temperature.

Synthesis Via Seeding Crystallization:

210 mL of water were placed at room temperature (Tₛₑₜ=25° C.) in a 1.2 L thermostatted glass reactor equipped with mechanical bottom stirring (IKA® 1000 reactor), internal temperature control and a water condenser. While stirring (70 rpm) 91 g of Sodium Chloride and 504 g of (D)-(+)-Sucrose were added over a period of 10 minutes. Then, the temperature was set to 85° C. and a colorless solution was obtained over a period of 45 minutes. Afterwards, the temperature was set to 25° C. and the solution slowly cooled to 25° C. within 105 minutes. At this point, the stirring was reduce to 30 rpm and 500 mg of seeding crystals (Sucrose⋅NaCl⋅2 H₂O) were carefully added to the solution. Crystallization occurred within the next minutes. In total, the crystallization took 24 hours since the addition of the seeding crystals. Finally, stirring was halted and the suspension subsequently filtered over a glass frit under reduced pressure (Borosilicat glass: 3.3; Porosity: 3; 600 mPa; Büchi Vacuum Pump V-700). The solid product was dried at 40° C. for 15 hours (Wisag drying oven) and 250.3 g of the co-crystalline Sucrose⋅NaCl⋅2 H₂O were obtained as a white powder (yield: 39%). The crystalline material was stored in tightly closed aluminium containers at ambient temperature.

### Example 13

Dissolution Kinetics Via Refractometry for the System Sucrose/Sodium Chloride

Changes in refraction of the solution were measured at room temperature while adding a defined amount of solid material to the solvent (60 mL of water) under constant stirring. Results shown in FIG. 7. The equipment used is composed of a magnetic stirrer and a digital refractive index probe (Fiso technologies) capable of constant measurement. Once the powder is added, refractive indices are recorded as a function of time. This technique was used to compare the dissolution behavior of the sucrose⋅NaCl⋅H₂O co-crystal with its pure individual components as well as the physical mixture of the two pure ingredients. The particle size of all solids was standardized to be in between 63-100 μm.

Quantities Used for the Measurements:

NaCl: 0.268 g

Sucrose: 1.57 g

Sucrose⋅NaCl⋅H₂O co-crystal 2.00 g

Water 60 mL

As can be seen in FIG. 7, pure sodium chloride dissolves the fastest, but the sucrose⋅NaCl⋅H₂O co-crystal dissolved almost as fast. Pure sucrose alone dissolves much slower, followed by sodium chloride in the presence of sucrose (physical mixture), which dissolves significantly slower than any of the other solids investigated here. The co-crystal is shown to dissolve faster than the equivalent physical mix.

1. Solid or semi-solid nutritional composition comprising carbohydrate⋅sodium chloride co-crystals.

2. Solid or semi-solid nutritional composition according to claim 1, wherein the carbohydrate is selected from the group consisting of monosaccharides, disaccharides, mixtures of different monosaccharides, mixtures of different disaccharides, and mixtures of monosaccharides and disaccharides.

3. Solid or semi-solid nutritional composition according to claim 2, wherein the monosaccharide is selected from the group consisting of pentoses, and hexoses.

4. Solid or semi-solid nutritional composition according to claim 2, wherein the disaccharide is selected from the group consisting of Sucrose, Lactulose, Lactose, Maltose, Trehalose, Cellobiose, Chitobiose, Kojibiose, Nigerose, Isolmaltose, beta,beta-Trehalose, alfa,beta-Trehalose, Sophorose, Laminaribiose, Gentiobiose, Turanose, Maltulose, Palatinose, Gentiobiulose, Mannobiose, Melibiose, Melibiulose, Rutinose, Rutinulose, and Xylobiose.

5. Solid or semi-solid nutritional composition according to claim 1, wherein the co-crystals are hydrated or non-hydrated co-crystals.

6. Solid or semi-solid nutritional composition according to claim 1, wherein the carbohydrate⋅sodium chloride co-crystals are selected from the group consisting of (Glucose)₂⋅sodium chloride⋅monohydrate, Ribose⋅sodium chloride, Sucrose⋅sodium chloride ⋅2 H₂O, and combinations thereof.

7. Solid or semi-solid nutritional composition according to claim 1, wherein the composition comprises the carbohydrate ⋅sodium chloride co-crystals in a concentration of 0.01-100 wt % based on the weight of the composition.

8. Solid or semi-solid nutritional composition according to claim 1, wherein the composition comprises the carbohydrate⋅sodium chloride co-crystals in a concentration of 0.01-5 wt % based on the weight of the composition.

9. Solid or semi-solid nutritional composition according to claim 1, wherein the nutritional composition is selected from the group consisting of a food product, a functional food product, a frozen food product, a dairy product, a microwaveable food product, a confectionery product, a culinary product, a nutritional supplement, and a pet food product.

10. Solid or semi-solid nutritional composition according to claim 8, wherein the nutritional composition further comprises a nutrient selected from the group consisting of fat, protein, vitamin, mineral and carbohydrate.

11. (canceled)

12. Process for preparing carbohydrate⋅sodium chloride co-crystals comprising the steps of:
preparing a saturated solution comprising a sodium chloride and carbohydrate;
adding a seeding crystal of carbohydrate⋅sodium chloride co-crystal or a co-crystal isostructural with a carbohydrate⋅sodium chloride;
allowing the formation of crystal; and
isolating the obtained crystals.

13. Process for preparing carbohydrate⋅sodium chloride co-crystals according to claim 12 wherein the preparation of the saturated solution comprises the steps of preparing a solution comprising a sodium chloride and carbohydrate at a temperature of 15-75° C. and cooling the solution to 25-40° C.

14. Process for preparing carbohydrate⋅sodium chloride co-crystals according to claim 12 wherein the carbohydrate⋅sodium chloride co-crystals are sucrose⋅sodium chloride co-crystals, the process comprising the steps of:
preparing a saturated solution of sodium chloride and sucrose;
adding a seeding crystal of sucrose⋅sodium bromide;
allowing the formation of crystal and;
isolating the obtained crystals.

15. Process for preparing a nutritional composition comprising the steps of:
preparing a saturated solution comprising a sodium chloride and carbohydrate; adding a seeding crystal of carbohydrate⋅sodium chloride co-crystal or a co-crystal isostructural with a carbohydrate⋅sodium chloride; allowing the formation of crystal; and isolating the obtained crystals; and
adding thereto a nutrient selected from the group consisting of fat, protein and carbohydrate.
